(19) United States
(12) Patent Application Publication
(10) Pub. No.: US 2025/0392927 A1
(43) Pub. Date: Dec. 25, 2025

(54) DYNAMICALLY UPDATING SERVICE PRIORITIES FOR NETWORK FUNCTIONS WITHIN A 5G NETWORK

(71) Applicant: Oracle International Corporation, Redwood City, CA (US)

(72) Inventors: Rajiv Krishan, Cary, NC (US); Geeta Mohanty, Bengaluru (IN)

(21) Appl. No.: 18/747,637

(22) Filed: Jun. 19, 2024

(51) Int. Cl. H04W 24/04; H04W 28/06

(52) U.S. Cl. CPC H04W 24/04; H04W 28/06

(57) ABSTRACT

Various embodiments of the present technology generally relate to systems and methods for providing an X-Service-State (XSS) engine that dynamically updates a service priority for network functions (NFs). In an aspect, a method is provided that includes determining, by a first NF producer within a NF set, an isolation event, where the isolation event isolates the first NF producer from at least one other NF producers within the NF set. The method may also include generating, by the first NF producer, a XSS header containing an X-Service (XS) status indicating that the first NF producer is isolated and includes a service priority and a first validity period during which the service priority is applicable. The method may also include transmitting, by the first NF producer, the XSS header to the NF consumer, where responsive to receiving the XSS header the NF consumer uses the service priority for NF selection.

### TECHNICAL FIELD

Various embodiments of the present technology generally relate to network function communication within 5G networks. More specifically, embodiments of the present technology relate to systems and methods for providing an X-Service-State engine which dynamically updates service priorities for network functions within a 5G network.

### BACKGROUND

In a 5G network, network function (NF) producers, such as Policy Control Functions (PCFs) often operate in sets or groups to efficiently provide services or instances to NF consumers. These NF producers collaborate seamlessly to ensure the smooth delivery of network services, leveraging distributed computing and virtualization technologies. PCFs, which play a critical role in enforcing policies, managing quality of service (QoS0, and handling subscriber data, are typically deployed in clusters or pools across the network infrastructure. Within these clusters, individual PCFs work together to handle policy control, balance loads, and maintain high availability. By operating in sets, PCFs can dynamically allocate resources and scale capacity to meet fluctuating demands, ensuring optimal performance and reliability for NF consumers. This distributed approach not only enhances network scalability and flexibility but also enables efficient resource utilization and resilience against failures, ultimately delivering a seamless and responsive experience for users across the 5G ecosystem.

Events, however, can occur in which one or more of these NF producers become isolated from their mate NFs within the NF set. These events, often referred to as network disruptions or failures, can result from various factors such as hardware malfunctions, software errors, or network configuration issues. When an NF producer becomes isolated, it loses communication and coordination with its mate NFs, disrupting the seamless operation of the NF set. This isolation can lead to service degradation or even complete service outage for NF consumers relying on the affected NF producers.

In certain scenarios, the challenges of NF isolation are exacerbated by the fact that the affected NF may remain unaware of its isolation status. Despite losing communication with its mate NFs, the isolated NF may continue to receive service requests from NF consumers. This situation can be particularly problematic because the affected NF lacks visibility into the broader network context and cannot discern whether the issue lies with its mate NFs or with its own functionality. As a result, the isolated NF faces a dilemma: continue accepting service requests and risk session loss, or identify itself as isolated and potentially disrupt service availability for NF consumers.

Accordingly, there exists a need for improved systems and techniques for dynamically updating service priorities for NFs based on their isolation status. In particular, there is a need for an X-Service-State engine which can update a service priority for a respective NF responsive to identifying an isolation event. As will be described in greater detail below, the X-Service-State engine described herein provides for robust monitoring and diagnostic mechanisms to promptly detect and address NF isolation events. By enhancing NF awareness and facilitating informed decision-making, the X-Service-State engine can minimize the impact of isolation events and maintain the integrity of network services.

The information provided in this section is presented as background information and serves only to assist in any understanding of the present disclosure. No determination has been made and no assertion is made as to whether any of the above might be applicable as prior art with regard to the present disclosure.

### OVERVIEW

Technology is disclosed herein for systems and techniques for providing an X-Service-State (XSS) engine that dynamically updates service priorities from NF producers within a 5G environment. As will be described in greater detail below, the XSS engine may identify when an isolation event occurs. The isolation event may isolate a respective NF producer from its mate NFs within an NF set. When the XSS engine determines that the NF producer is isolated, the XSS engine may generate an XSS header. The XSS header may contain various information relating to the degraded status of the NF producer, including a service priority and a validity period during which the service priority is applicable.

As will be expanded on below, the service priority of the degraded NF producer may be used by a respective NF consumer for service routing (e.g., NF selection). As such, the service priority may be selected to render the affected NF producer as a least preferred NF selection (e.g., having a low priority). When the NF consumer receives the XSS header, the NF consumer may replace a priority parameter associated with the affected NF producer with the service priority. During NF selection or service routing, the NF consumer may then use the service priority. Because the NF consumer may use the service priority for the affected NF producer for service routing, the NF consumer can select a NF having a higher priority. In some cases, the NF having a higher priority may be another NF producer within the same NF set as the degraded NF producer or may be an NF in an entirely different NF set.

By providing the NF consumer with service priorities, the XSS engine is able to inform the NF consumer of degraded sites and allow the NF consumer to select an alternative site having a higher priority. As those skilled in the art readily appreciate, by selecting an NF producer with a high priority offers the benefit of ensuring prompt and preferential service delivery, optimizing resource allocation, and enhancing the overall reliability and responsiveness of the network function ecosystem within a 5G network.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

The accompanying drawings, which are incorporated into and constitute a part of this specification, illustrate one or more certain aspects and, together with the description of the example, serve to explain the principles and implementations of the certain examples.

FIG. 1 illustrates an example operational environment for a 5G network in which one or more features of a X-Service-State engine can be implemented, according to an embodiment herein;

FIG. 2 illustrates an example operational environment containing a NF set, according to an embodiment herein;

FIG. 3 illustrates an operational environment 300 in which an X-State-Service (XSS) engine dynamically updates a service priority of a NF producer within a NF set, according to an embodiment herein;

FIG. 4 provides an example XSS engine process, according to an embodiment herein;

FIG. 5 illustrates an example flow illustrating use of an XSS header to dynamically update the service priority of a NF, according to an embodiment herein;

FIG. 6 illustrates an example flow illustrating use of an XSS header to dynamically update the service priority of a NF, according to an embodiment herein;

FIG. 7 illustrates an example flow illustrating use of an XSS header to dynamically update the service priority of multiple NFs within a NF set, according to an embodiment herein; and

FIG. 8 shows an example computing device suitable for providing an XSS engine and its related functions, according to an embodiment herein.

Some components or operations may be separated into different blocks or combined into a single block for the purposes of discussion of some of the embodiments of the present technology. Moreover, while the technology is amenable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

The utilization of 5G networks is rapidly becoming ubiquitous and indispensable in modern society. With its promise of ultra-fast speeds, low latency, and massive connectivity, 5G technology is transforming the way we communicate, work, and live. From streaming high-definition content on mobile devices to powering autonomous vehicles and smart cities, the potential applications of 5G are virtually limitless. Businesses are leveraging 5G networks to enable remote work, enhance productivity, and drive innovation across various industries. Additionally, the proliferation of Internet of Things (IoT) devices, coupled with 5G's capacity to support a massive number of connected devices, is fueling the growth of smart homes, healthcare systems, and industrial automation. As 5G networks continue to expand and evolve, they are increasingly relied upon to deliver seamless connectivity and enable the next wave of technological advancements, shaping the future of society in profound ways.

To deliver a diverse range of services within the 5G network, network functions often operate in sets or groups, collaborating to ensure efficient service provisioning and delivery. These network functions, which encompass elements such as Packet Core Functions (PCFs), Radio Access Network (RAN) functions, and Service Management Functions (SMFs), work in tandem to meet the diverse requirements of different applications and use cases. By operating in sets, network functions can dynamically allocate resources, scale capacity, and distribute workloads to optimize performance and resource utilization. This collaborative approach enables the network to deliver a wide array of services, including enhanced mobile broadband, ultra-reliable low-latency communications (URLLC), and massive machine-type communications (mMTC). Whether supporting high-speed data transfers, mission-critical applications, or IoT deployments, the orchestrated operation of network functions in sets ensures the scalability, flexibility, and reliability necessary to meet the evolving demands of modern connectivity.

In the dynamic landscape of 5G networks, events can occasionally occur where one or more NFs within an NF set become isolated from each other and/or other NFs outside of the set. These events, often triggered by hardware failures, software bugs, or network configuration issues, disrupt the seamless coordination and communication between NFs, leading to service degradation or interruption. Isolation can occur when NFs lose connectivity due to network partitioning, equipment malfunctions, or software errors, rendering them unable to exchange information or synchronize operations with their peers. As a result, affected NFs may operate in isolation, unable to fulfill their intended functions or collaborate effectively with other network elements. These isolated NFs pose challenges for service continuity, as they may inadvertently propagate faulty responses or exhibit degraded performance in the absence of coordinated orchestration.

In certain instances, a Network Function (NF) within an NF set may find itself in a state of uncertainty regarding its isolation status. Despite potential connectivity issues with its mate NFs, the NF in question may continue to receive service requests from NF consumers. This situation can lead to ambiguity, as the NF is unable to discern whether the problem lies with its own isolation or with its mate NFs. Without clear indicators or communication channels to its peers, the isolated NF may struggle to determine the root cause of the issue. Consequently, it faces a dilemma: continue processing service requests, risking the loss of session data, or identify itself as isolated and potentially disrupt service availability for NF consumers.

Another significant issue that arises from isolation events within NF sets is the split-brain recovery scenario. In this situation, when network partitions occur, individual NFs within the set may attempt to independently recover from the isolation by initiating self-healing mechanisms. However, without a coordinated recovery strategy, conflicting actions may be taken by different NFs, leading to a “split-brain” scenario where the NF set becomes fragmented and divergent states emerge. As a result, the network may experience inconsistencies, data loss, or service disruptions, as NFs within the same set operate autonomously without synchronization. Split-brain recovery poses a considerable challenge for network operators, as restoring consistency and coherence across the NF set requires sophisticated coordination and reconciliation mechanisms.

To address at least these issues, example X-Service-State (XSS) engines are provided herein. As will be described in greater detail below, the XSS engines provided herein may dynamically update service priorities of a NF instance(s) affected by an isolation event. In an embodiment, an XSS engine may determine that an isolation event has occurred and responsive to the isolation event generate an XSS header. The XSS header may be similar to a 3gpp-Sbi-OCI (Out-of-Context Indicator) or a 3gpp-Sbi-LCI (Lost Context Indicator) header as captured in 3GPP technical specification 29.500 in that it includes a metadata element used to indicate that the respective NF has lost connectivity or synchronization with its mate NFs or in the broader network context.

As part of the XSS header, the XSS engine may generate a service priority and a validity period for the service priority. As those skilled in the art readily appreciate, each NF within a 5G network may have a corresponding NF profile associated with it by a corresponding NF Repository Function (NRF). The NF profile may be used to facilitate service discovery and orchestration of the NF by NF consumers. This profile typically includes essential information such as the capabilities, resource requirements, and supported interfaces of the NF. Additionally, the NF profile may incorporate an assigned priority parameter, which denotes the relative importance or criticality of the NF within the network architecture, aiding in resource allocation and prioritization during network operation.

As will be described in greater detail below, the service priority provided in the XSS header may be used by NF consumers in place of the assigned priority parameter in a respective NF profile registered by a corresponding NF with an NRF. The service priority generated by the XSS engine may be such that the service priority places the affected NF lower than the other NF mates within the NF set. Because the NF consumers use a NF's priority for NF selection (e.g., service routing) the NF consumers will select NFs having higher priorities (e.g., higher priority parameters or service priorities) than the affected NF. In this manner, the NF consumers can avoid sending service requests to an isolated NF, thereby avoiding or minimizing the above described negative outcomes of routing to an isolated NF. As such, the XSS engine provided herein ensures the reliability, resilience, and quality of service in 5G networks by providing prompt event detection and rerouting of service requests during NF isolation events. By implementing robust protocols and distributed coordination techniques, the XSS engine can mitigate the risks associated with split-brain recovery and ensure the integrity and reliability of the network infrastructure.

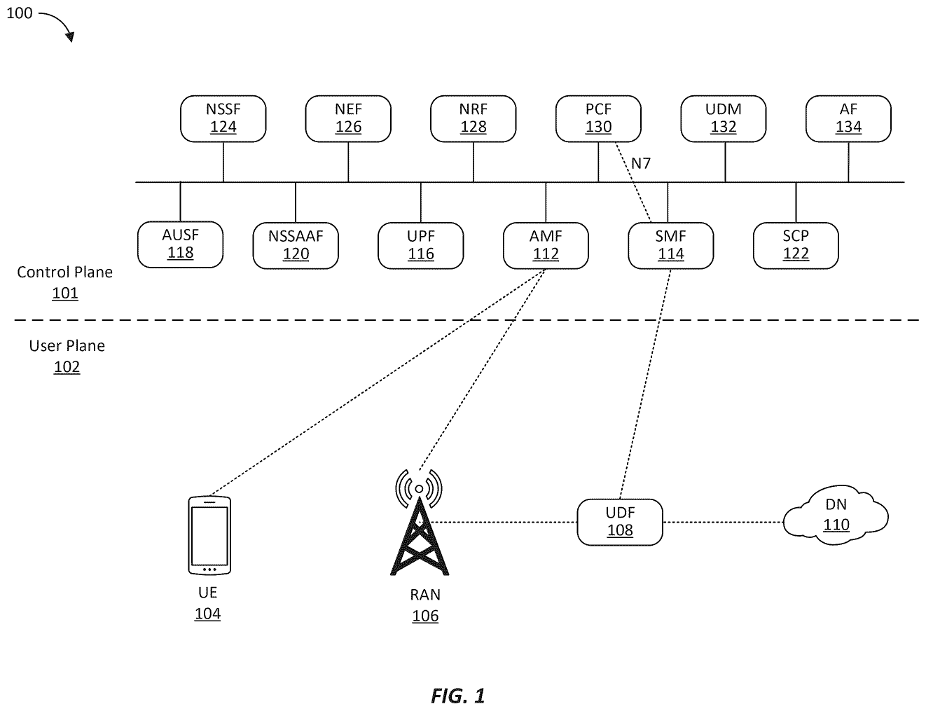

Turning now to the Figures, FIG. 1 illustrates an example operational environment for a 5G network 100 in which one or more features of a X-Service-State engine can be implemented, according to an embodiment herein. The example 5G network 100 is a 5G core (5GC) cellular network implementing 3GPP (3rd Generation Partnership Project) communication standards, although the present disclosure may apply to other communication networks.

The 5G network 100, its components, and their sub-components may be implemented via computers, servers, hardware and software modules, or other system components. The components of the 5G network 100 and its subcomponents, or the physical devices implementing them, may be co-located, remotely distributed, or any combination thereof. The elements of 5G network 100 may include components hosted or situated in the cloud and implemented as software modules potentially distributed across one or more server devices or other physical components.

The 5G network 100 is divided into two fundamental planes: a control plane 101 and a user plane 102, each serving distinct yet interdependent roles. The control plane 101 is responsible for managing the signaling and control information necessary to establish, modify, and terminate communication sessions. The control plane 101 handles tasks such as authentication, policy enforcement, and mobility management. As such, the control plane 101 is crucial for orchestrating and controlling the NFs, ensuring efficient and secure connectivity. On the other hand, the user plane 102 deals with the actual data transmission—the movement of user data between devices and applications. It is optimized for high-throughput, low-latency data delivery, and is designed to efficiently transport user traffic. The separation of the control plane 101 and user plane 102 in the 5G network 100 enhances scalability, flexibility, and enables network slicing, allowing tailored configurations to meet diverse service requirements. Together, these planes 101 and 102 form a cohesive architecture that empowers the 5G network 100 to deliver unprecedented speed, reliability, and versatility for a wide array of applications and services.

As noted above, the user plane 102 of the 5G network 100 operates in tandem with the control plane 101 to deliver efficient and seamless data transmission. For example, as illustrated, when a User Equipment (UE) 104, which could be a smartphone or any other device, initiates a communication the user plane 102 handles the actual user data traffic. When the UE 104 initiates communication, the Radio Access Network (RAN) 106 comes into play, managing the wireless connection between the UE 104 and the network 100, in particular the UE 104 and the Access and Mobility Management Function (AMF) 112. The RAN 106 acts as the bridge between the user plane 102 and the control plane 101, facilitating the establishment of communication sessions. As data travels through the RAN 106, it encounters the User Data Function (UDF) 108, which plays a pivotal role in processing and optimizing user data. The UDF 108 is responsible for tasks such as traffic optimization, content caching, and data transformation, enhancing the efficiency of data delivery.

The UDF 108 provides the data to the Data Network (DN) 110, which could represent the broader internet or a specific network service. The DN 110 processes and delivers the user data to its intended destination, completing the journey initiated by the UE 104. The collaborative operation of the user plane 102, UE 104, RAN 106, UDF 108, and DN 110 ensures that data is transmitted reliably and efficiently, meeting the high-performance expectations of 5G networks. As those skilled in the art readily appreciate, the separation of user plane 102 and control plane 101 allows for flexible network configurations and optimizations, contributing to the enhanced capabilities of the 5G ecosystem.

As noted above, when the UE 104 initiates a communication within the 5G network 100, the AMF 112 coordinates the interaction. For example, when the UE 104 initiates communication or moves within the 5G network 100, it sends signaling messages to the AMF 112. The AMF 112 is responsible for tasks such as authentication, authorization, and mobility management. Upon receiving the signaling messages from the UE 104, the AMF 112 validates the user's identity, checks for necessary permissions, and establishes the necessary context for the session. The AMF 112 coordinates with other network functions, such as the Session Management Function (SMF) 114 and the User Plane Function (UPF) 116, to ensure the seamless setup and management of communication sessions. The interaction with the control plane 101 enables the UE 104 to access network services, adhere to established policies, and maintain continuous connectivity while benefiting from the advanced capabilities and optimizations offered by the 5G network architecture.

The control plane 101 includes example components, nodes, or NFs. As illustrated, the control plane 101 includes the AMF 112, the SMF 114, the UPF 116, an Authentication Server Function (AUSF) 118, a Network Slice-Specific Authentication and Authorization Function (NSSAAF) 120, Service Communications Proxy (SCP) 122, a Network Slice Selection Function (NSSF) 124, Network Exposure Function (NEF) 126, a Network Repository Function or NF Repository Function (NRF) 128, a Packet Core Function (PCF) 130, a Unified Data Management (UDM) 132, and an Application Function (AF) 134. The selection of NFs 112-134 depicted in the 5G network 100 is exemplary, and some of the NFs 112-134 may be excluded, or other NFs added to the collection, without departing from the scope of this disclosure. The various NFs 112-134 execute various operations to provide communication services to UEs, such as the UE 104, that connects to the 5G network 100. A network node or NF that provides service is referred to herein as a NF producer, while a network node or NF that consumes services is referred herein to as a NF consumer. A network function can be both a NF producer and a NF consumer depending on whether it is consuming or providing service.

The NFs 112-134 of the 5G network 100 exchange various communications in the course of providing network services. The communications may include messaging to establish or end secured communication channels, such as transport layer security (TLS) handshakes, as well as service-based interface (SBI) communications. As used herein, SBI is the term given to the application programming interface (API) based communication that can take place between two NFs within the 5G SBA. A given NF can utilize an API call over the SBI to invoke a particular service or service operation. Communications between NFs 112-134 may be performed over network links and communication channels of the 5G network 100 that are not explicitly depicted in FIG. 1.

When the UE 104 initiates communication within the 5G network 100, various network functions often operate in pairs, where one NF acts as the producer (“the NF producer”), generating or providing specific services or information, and the other NF acts as the consumer (the “NF consumer”), utilizing or consuming the produced services or information to complete service requests. For instance, consider the interaction between the SMF 114 and the Packet Core Function (PCF) 130. The SMF 114, as the NF consumer, initiates service requests related to session establishment, modification, or termination for UE sessions, such as for the UE 104. The SMF 114 communicates these requests to the PCF 130, acting as the NF producer, which performs functions related to session management, Quality of Service (QoS) enforcement, and access control. The PCF 130 processes the requests from the SMF 114, enforces QoS policies, manages session establishment and modification, and ensures appropriate access control based on network policies and conditions. Through this producer-consumer interaction, the SMF 114 and PCF 130 collaborate to deliver efficient and reliable service within the 5G network architecture.

As those skilled in the art readily appreciate, various NFs may act as NF producers and NF consumers. For example, a NF producer may be or include the PCF 130, the SMF 114, a unified data repository (UDR) (not shown), a charging function (CHF), Binding Support Function (BSF) (not shown) or a Network Data Analytic Function (NWDAF) (not shown). depending on the operation and the service request. A NF consumer may be or include the UE 104, a service capability function (SCF) (not shown), the SCP 122, the SMF 114, the AMF 112, the NEF 126, a service enablement platform provider (SEPP) (not shown), the AF 134, the UDR, or a charging function (CHF), depending on the operation and the service request.

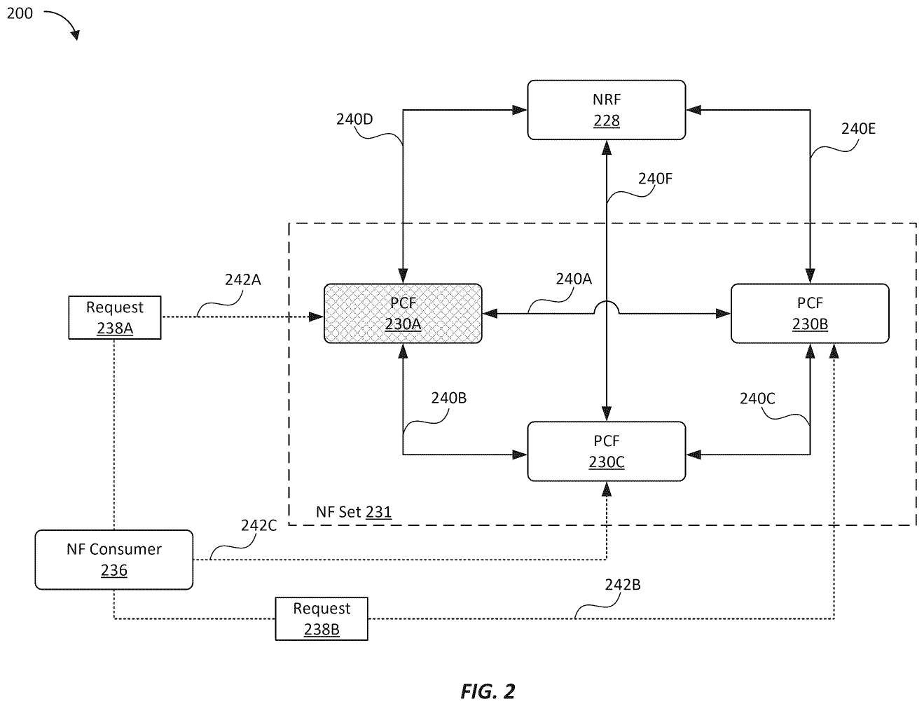

In some cases, NF producers, such as the PCF 130 may collaborate within sets or groups, referred to herein as “NF sets” to provide instances or services to NF consumers. Referring now to FIG. 2, an example operational environment 200 illustrating a NF set 231 is provided, according to an embodiment herein. As shown, the NF set 231 may include three PCFs: PCF 230A, PCF 230B, and PCF 230C. In a NF set 231, the PCFs 230A-C may collaborate to efficiently service requests from NF consumer 236, which may be a client device, the SMF 114, the AMF 112, a SCP, or SEPP, and ensure reliability for sessions within the network. In the illustrated environment 200, the NF consumer 236 may interact with the PCF 230A via communication 242A, the PCF 230B via communication 242B, and the PCF 230C via communication 242C. It should be appreciated that while the remaining discussion involves the NF producers being PCFs, here PCFs 230A-C, the following discussion is equally applicable to other NF producers, such as SMF or UDR. As the skilled artisan readily appreciates, almost any NF in a 5G environment can act as a producer at some point. Similarly, it should be appreciated that the NF consumer 236 may be or include a user equipment, SCF, SCP, SMF, AMF, NEF, SEEP, AF, UDR, or CHF.

Through orchestrated communication and coordination, the PCFS 230A-C function within the NF set 231 to process service requests, manage session establishment and maintenance, and enforce policies and rules for the NF consumer 236. This collaborative approach enhances fault tolerance and resilience, ensuring uninterrupted service delivery and maintaining the integrity of sessions across the network. As illustrated, the PCF 230A may communicate with the PCF 230B and the PCF 230C (and vice versa) via communications 240A and 240B, respectively. Similarly, the PCF 230B may communicate with the PCF 230C (and vice versa) via communication 240C.

The PCFs 230A-C within the NF set 231 may synchronize and replicate data between sites to ensure session continuity and resilience across the network. Through these mechanisms, data pertaining to session states, configurations, and policies are shared and mirrored among NF instances (PCFs 230A-C), enabling seamless failover and redundancy. Synchronization ensures that each NF within the NF set 231 maintains consistent and up-to-date information, while replication safeguards against data loss by creating redundant copies across multiple sites. By synchronizing and replicating data, the PCFs 230A-C can effectively mitigate the impact of network disruptions or failures, ensuring uninterrupted service delivery and maintaining the integrity of sessions within the 5G network architecture.

In addition to servicing requests from the NF consumer 236, the PCFs 230A-C within the NF set 230 may also maintain communication with NFs outside of NF consumers, such as a NRF 228. This communication enables the PCFs 230A-C to exchange information related to service discovery, network topology, and resource availability with the NRF 228 facilitating efficient orchestration and management of network functions across the 5G architecture. Through these interactions, the PCFs 230A-C can dynamically adapt to changing network conditions, optimize resource allocation, and ensure seamless service delivery within the network. In the illustrated environment 200, the PCF 230A may communicate with the NRF 228 via communication 240D, the PCF 230B may communicate with the NRF 228 via communication 240E, and the PCF 230C may communicate with the NRF 228 via communication 240F.

As shown, the NF consumer 236 may route service requests to each of the PCFs 230A-C based on a NF selection (e.g., service routing). As those skilled in the art readily appreciate, each of the PCFs 230A-C may have a corresponding NF profile which includes various parameters that are published at the NRF 228. The NF profile generally includes essential information for a respective NF, such as the capabilities, resource requirements, and supported service interfaces of the NF. The NF profile may also include a priority parameter that is used to facilitate service discovery and orchestration by the NF consumer 236. The priority parameter may denote the relative importance or criticality of a respective PCF 230A-C within the network architecture. As such, the NF consumer 236 may use the priority parameter to determine resource allocation and prioritization during network operation. In other words, the NF consumer 236 may use the priority parameter to determine which of the PCFs 230A-C to route a service request.

As noted above, isolation events, such as hardware failures, software bugs, or network configuration issues, may cause one or more of the PCFs 230A-C to become isolated from each other and/or other NFs, such as the NRF 228. For example, there may be an isolation event which causes the PCF 230A to lose communications 240A and 240B with the PCF 230B-C. In other words, the PCF 230A is isolated from its “NF mates” 230B and 230C. Because the PCF 230A is isolated from its NF mates, the PCF 230A may not be able to exchange messages via the communications 240A-B. In another example, the PCF 230A may become isolated from the PCFs 230B-C and the NRF 228. As such the PCF 230A may lose communications 240A-B and 240D with he PCFs 230B-C and the NRF 228.

In these scenarios, however, the PCF 230A may still be able to receive requests 238A from the NF consumer 236 via the communication 242A. When the PCF 230A receives the request 238A from the NF consumer 236, the PCF 230A may process the request but is unable to replicate data to the other sites within the NF set 231 (e.g., PCFs 230B-C). As such, the NF consumer 236 cannot be served or continue service with the PCFs 230B-C because these sites did not receive the replicated data from the PCF 230A. Accordingly, if the NF consumer 236 can no longer reach the PCF 230A or the PCF 230A becomes overloaded and the NF consumer 236 is required to redirected the requests 238A, there may be session loss or failure due to the PCF 230B and PCF 230C lacking the data associated with an ongoing session.

The PCF 230A may not be able to determine whether the issue causing the isolation event is with itself or with the other NFs in the network (e.g., NRF 228, PCFs 230B-C). For example, the PCF 230A cannot determine if the isolation event is a local network issue (e.g., routing/firewall rules) and the PCFs 230B-C are available/healthy or if the isolation event is a broader network issue (e.g., network router failure), wherein the PCFs 230B-C and NRF 228 have failed, meaning it is the only legitimate instance available within the NF set 231. Because the PCF 230A is unable to make this determination, it cannot make a prompt determination of whether it should continue accepting the requests 238A from the NF consumer 236, including creating new sessions that may fail later, or stop accepting the request 238A and shut down/restart.

In embodiments where the PCF 230A becomes isolated from the NRF 228, the loss of connectivity (e.g., communication 240D) with the NRF 228 may trigger a Heartbeat (HB) failure, prompting the NRF 228 to mark the affected PCF 230A as suspended. However, during this period, indicated by a set number of HB failures, new discovery requests (transmitted as part of NF selection) can still provide the NF profile of the suspended PCF 230A in discovery responses. As such the NF consumer 236 (and other NF consumers present within the overall network) may utilize this information for routing purposes or NF selection. Additionally, for discovery responses with extended validity periods or for NFs, such as the PCF 230A, with pre-established profiles, the NF consumer 236 may continue to prioritize the suspended site for setting up new sessions, considering factors such as locality and other preferences. In other words, even if the PCF 230A is suspended by the NRF 228 due to communication 240D loss, the NF consumer 236 may persist in utilizing the suspended PCF 230A for service requests. Consequently, any updates made to the suspended PCF 230A carry the risk of losing updated context in the event of complete failure. As can be appreciated, this impacts the overall resiliency of sessions or instances managed by the NF set 231.

When complete network isolation occurs between instances of NFs within the NF set 231 (e.g., PCFs 230A is isolated from the PCFs 230B-C and NRF 228), the session state data, whether for new sessions or updates to existing ones, remains localized to each individual site. This means that if a session, such as N7, is accepted by PCF 230A, subsequent requests related to that session must be directed to PCF 230A exclusively, even if other NF instances within the NF set 231, like PCF 230B and PCF 230C, are present. As a consequence, there is a risk that the NFs may be working on stale session data for NF instances that do not have access to the latest data from mate sites. Consequently, deterministic routing becomes necessary when multiple instances within the NF set 231 encounter split-brain issues to ensure consistent handling of sessions. Additionally, when the PCFs 231A-C utilize shared and replicated data, such as to recover from an isolation event, split-brain recovery can lead to the loss of sessions. In split-brain scenario, one of the PCFs 230A-C may be designated as the “golden” instance, and other sites recover by restoring data from this instance, resulting in the loss of sessions accepted or updated by other sites.

As can be seen, current systems and techniques for NF selection and service routing between the NF consumer 236 and one or more sites within the NF set 231 fail to promptly indicate when a NF producer is isolated and/or inform the NF consumer 236 of an isolation event. As such, session resilience and user experience may be impacted by delayed service, session discontinuity, or even complete session loss. Accordingly, there is a need for improved systems and techniques for service routing and NF selection.

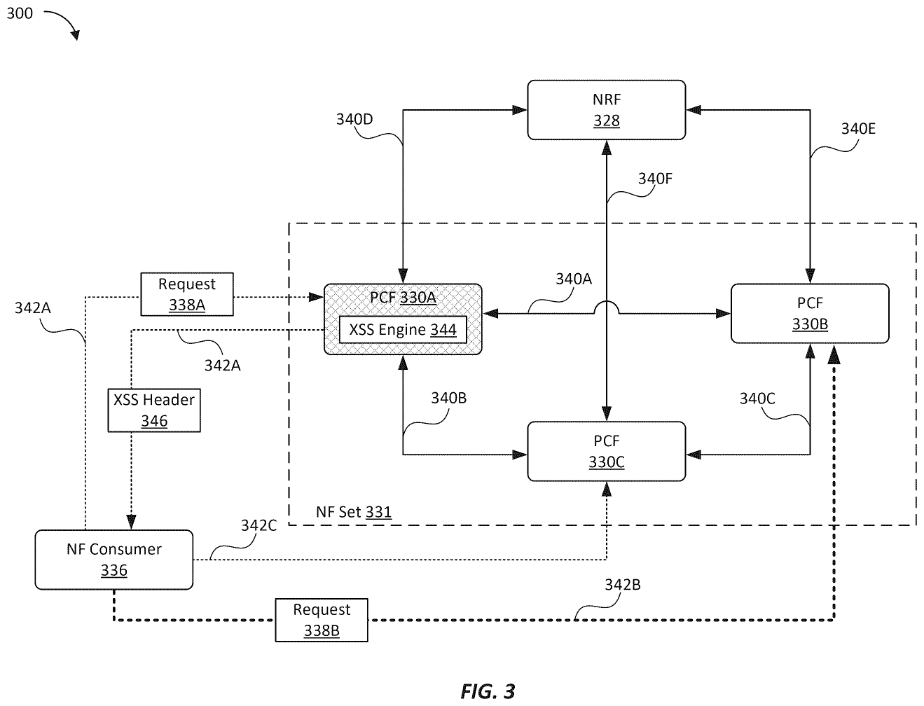

Referring now to FIG. 3, an operational environment 300 is illustrated in which an X-State-Service (XSS) engine 344 dynamically updates a service priority of a NF producer within a NF set 331, according to an embodiment herein. The environment 300 may be the same or similar to the environment 200 in that it includes a NF set 331 containing three NF producers, here PCFs 330A-C that are in communication with each other via communications 340A-C. The environment 300 also includes a NRF 328 and a NF consumer 336, which may be the same or similar to the NRF 228 and the NF consumer 236, respectively. As shown, the NRF 328 may be in communication with the PCFs 330A-C via a communication 340D-F, respectively, and the NF consumer 336 may be in communication with the PCFs 330A-C via a communication 342A-C, respectively.

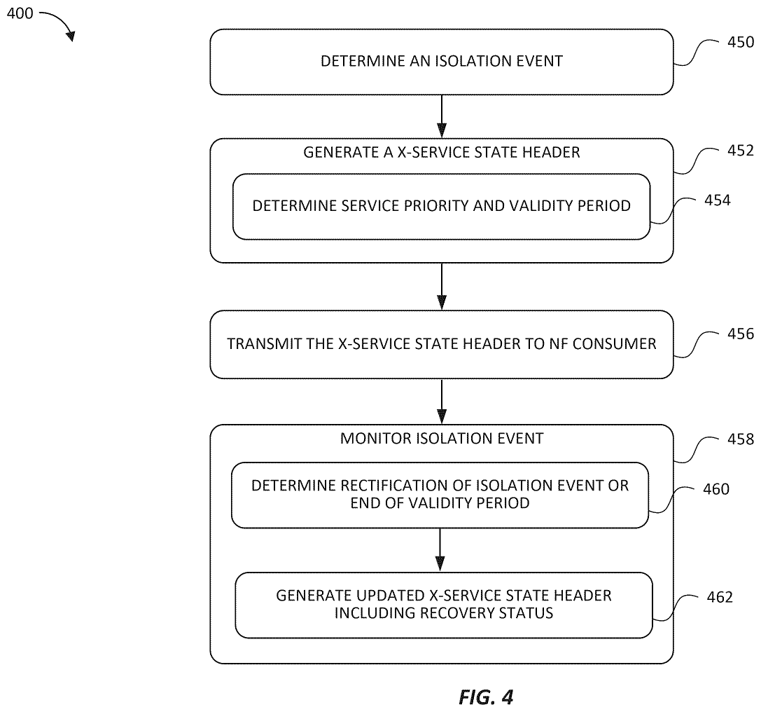

For ease of explanation, FIG. 3 is described in conjunction with FIG. 4, which provides an example XSS engine process, in particular a process 400 for providing the XSS engine 344 and one or more of its functions, according to an embodiment herein. In other words, FIG. 4 illustrates the process 400 for dynamically updating a service priority of a respective NF producer. While FIG. 4 is described with relation to FIG. 3, it should be appreciated that components, elements, and steps from any other Figures described herein may be equally applicable.

At some point, the PCF 330A may experience an isolation event in which it loses connectivity (e.g., communication 340B-C) with the PCFs 330B-C. In some cases, the PCF 330A may also lose connectivity (e.g., communication 340D) with the NRF 328. Despite being isolated from its site mates (e.g., PCFs 330B-C), the PCF 330A may receive request 338A from the NF consumer 336. Instead of processing the request 338A, however, the PCF 330A may determine the occurrence of an isolation event (e.g., that it is isolated from its site mates) (450). As those skilled in the art readily appreciate, the PCF 330A may determine its health state or isolation state through replicated tables, proprietary signaling instances, and the like.

Once the PCF 330A determines that it is isolated, and thus has a degraded status, the PCF 33A may inform the NF consumer 336 of its status (e.g., degraded). To inform the NF consumer 336 of the isolation event, the PCF 330A may generate an X-State-Service (XSS) header 346, indicating its degraded status (452). To generate the XSS header, the PCF 330A may include the XSS engine 344. It should be appreciated that each of the PCFs 330A-C in the NF set 331 may have a respective XSS engine 344, however, for case of explanation only the XSS engine 344 of PCF 330A is described herein.

In some embodiments, the PCF 330A may generate the XSS header once it is isolated from a threshold number of site mates (e.g., PCF 330B-C). For example, the PCF 330A may issue an XSS header once it becomes isolated from more than 25%, more than 50%, or more than 75% of its site mates. As can be appreciated, in the scenario where there are more PCFs in a NF set, then having this threshold may facilitate the PCF 330A in determining whether the issues is with its site mates or itself.

As noted above, the XSS engine 344 may generate the XSS header 346 containing an X-Service (XS) status indicating the degraded status of the PCF 330A. The XS status may include a variety of parameters or metadata relating to the degraded status of the PCF 330A. For example, the XS status may include a service priority for the PCF 330A during the isolation event and a validity period during which the service priority should be used in place of the assigned priority parameter. Additional parameters that may be included in the XS status may include a timestamp indicating a time at which the XSS header 346 was generated and a service instance indicating an instance impacted by the isolation event.

The XSS header 346 may be on a similar line of OCI/LCI headers as discussed in TS 29.500-5.2.3.2.9 3gpp-Sbi-Oci OR 5.2.3.2.10 3gpp-Sbi-Lci. As such, the XSS header 346 may be in the following form:
X-Service-State=“X-Service-Status:” OWS timestamp 1*(“;” OWS
serviceInstance [“;” OWS servicePriority “;” OWS validityPeriod]), where:
   timestamp=“timestamp=” DQUOTE date-time DQUOTE
   serviceInstance=“nfservinst=” token
   servicePriority=“priority=” (“PV” % x (PVrange))
   validityPeriod=“period-of-Validity=” 1*DIGIT “s”

To determine the XS status responsive to the isolation event, the XSS engine 344 of the PCF 330A may first determine a service priority for the PCF 330A and a validity period during which the service priority is applicable (454). The service priority for the PCF 330A may be selected from a predefined range of priority values (PVs). The range of priority values may be a range of high numbers, such as in the thousands (e.g., 65,530-65,535), to ensure that the affected PCF 330A becomes one of the lowest ranking or least preferred NF producers during routing processes or NF selection processes. As those skilled in the art readily appreciate, the lower in value the priority parameter of an NF is, the higher in priority the NF may be within an NF selection process (e.g., service routing). As such, by defining the priority value range to be sufficiently high enough, this can ensure that affected or isolated NFs are identified as having low priorities and are the least preferred during these processes. The priority value range may be predetermined by a consumer, an operator, or by any other means known.

In some embodiments, the XSS engine 344 may determine a service priority from the priority value range based on the timing of the isolation event. For example, if at a first time the PCF 330A experiences an isolation event and at a second time after the first time, the PCF 330B experiences an isolation event, then the XSS engine 344 may select the lowest value from the priority value range for the service priority of the PCF 330A since its isolation event occurred first. The XSS engine 344 may then select the next lowest value from the priority value range for the service priority of the PCF 330B since its isolation event occurred next.

In other embodiments, the XSS engine 344 may determine a service priority from the priority value range based on the isolation event and its impact on the connectivity of the PCF 330A to the other NFs. For example, if the PCF 330A is only isolated from the PCFs 330B-C but retains connectivity (e.g., communication 340D) with the NRF 328, then the XSS engine 344 may select the lowest value from the priority value range. In contrast, if the XSS engine 344 determines that the PCF 330A is isolated from the NRF 328, as well as the other sites within the NF set 331, then the XSS engine 344 may select the highest value from the priority value range.

By selecting a service priority from the priority value range based on the extent of isolation that the PCF 330A is experiencing, the XSS engine 344 can order the priority of affected NFs based on their retained functionality. For example, in some scenarios, in addition to the PCF 330A experiencing an isolation event, one or more of the PCFs 330B-C may also be experiencing an isolation event. If the NF set 331 is providing an on-going session to the NF consumer 336, instead of ending the session, the XSS engine 344 may provide service priorities for each of the affected PCFs which orders their respective priorities based on retained functionality. For example, if the PCF 330A is only isolated from its site mates (e.g., PCFs 330B-C) but maintains communication 340D with the NRF 328, then the XSS 344 engine may assign the PCF 330A a lower (numerical) service priority than the PCFs 330B which is isolated from its site mates as well as the NRF 328. For example, the PCF 330A may have a service priority of 65,330 and the PCF 330B may have a service priority of 65,335. Because the PCF 330A has a lower service priority than the PCF 330B, the PCF 330A has a higher priority than the PCF 330B and thus may be a more preferred NF option for the NF consumer 336 than the PCF 330B.

In addition to determining a service priority, the XSS engine 344 may determine a validity period during which the service priority is applicable. As noted above, when the PCF 330A experiences the isolation event, the service priority may replace the priority parameter assigned to the PCF 330A by its respective NF profile. Since the isolation event is a temporary event, the service priority's replacement of the priority parameter may only be for a limited time duration. The validity period sets this limit and once the validity period expires, the service priority may revert back to the priority parameter. As can be appreciated, the validity period may range in time duration and be application or session dependent. In some cases, the validity period may be based, in part, on the type of isolation event. In example embodiments, the validity period may be up to 1 minute, up to 5 minutes, up to 10 minutes, up to 30 minutes, up to 1 hour, or up to 3 hours.

As noted above, the XS status may also include a timestamp and a service instance. The timestamp may be the time at which the PCF 330A determines that it is isolated, which may be approximately the same as when the XSS header 346 is generated. The service instance may be or include the instance ID of the service in the PCF 330A's profile, such as a service token.

Once generated, the XSS header 346 may be transmitted to the NF consumer 336 (456). In some cases, the XSS header 346 may be transmitted to the NF consumer 336 as part of a response to the request 338A. It should be appreciated that while this illustrated example shows the XSS header 346 being generated responsive to the request 338, in some embodiments the PCF 330A may generate the XSS header 346 and transmit it to the NF consumer 348 without receiving the request 338A. For example, in some embodiments, the PCF 330A may generate and transmit the XSS header 346 responsive to determining the isolation event. In other embodiments, the PCF 330A may generate and transmit the XSS header 346 responsive to a health check API, such as those discussed in U.S. application Ser. No. 18/532,857, which is hereby incorporated by reference.

When the NF consumer 336 receives the XSS header 346 from the PCF 330A, the NF consumer 336 may replace the priority parameter of the PCF 330A with the service priority. As those skilled in the art readily appreciate, NF consumers, like the NF consumer 336, typically perform NF selection or service routing by leveraging priority parameters assigned to each NF producer, here PCFs 330A-C. These priority parameters, typically assigned within the NF profile associated with each NF producer, play a crucial role in guiding the selection process. Alongside priority, the NF profile contains essential information such as capacity, capabilities, and resource requirements, which collectively inform the decision-making process for NF selection. The NF consumers utilize this comprehensive profile data to assess the suitability of NF producers for servicing specific requests or routing services. By considering factors like priority, capacity, and capabilities, NF consumers can optimize service delivery, ensure efficient resource allocation, and maintain network performance within the 5G ecosystem. The NF profile, however, is static and as such does not update any of its parameters based on events impacting a NF producer.

Accordingly, if the NF consumer 336 relied on the priority parameter assigned to the PCF 330A during the isolation event, the NF consumer 336 may continue routing the request 338 to the PCF 330A and experience the aforementioned risks and drawbacks. As such, the XSS header 346 provides the NF consumer 336 with information relating to its current status, and indicates when the PCF 330A is experiencing an isolation event. The NF consumer 336 may replace the priority parameter for the PCF 330A with the service priority until the validity period expires or until the NF consumer 336 receives a notice that the PCF 330A has recovered.

During the validity period in which the NF consumer 336 uses the service priority of the PCF 330A for NF selection, the NF consumer 336 may select one of the PCF 330B or PCF 330C for service routing. For example, the NF consumer 336 may select the PCF 330B based on the priority parameter of the PCF 330B being lower than the priority parameter of the PCF 330C, along with other factors. As such, a request 338B may be routed to the PCF 330B. The request 338B may be the same or similar to the request 338A to which the NF consumer 336 initially attempted to route to the PCF 330A.

Depending on the status of the NF set 331 and/or the status of a session provided by the NF set 331, the NF consumer 336 may not select any of the NFs within the NF set 331. For example, the NF consumer 336 may select an entirely different NF set having healthy and fully available NFs over the NF set 331 due to the isolation event experienced by the PCF 330A. In other words, the NF consumer 336 may determine that one or more of the NFs within the NF set 331 have a degraded status based on a received XSS header and select a different NF set in which all of the NFs are available and healthy. As can be appreciated, the determination of whether to stay with the current NF set 331 or select an entirely different NF set may depend on the service request and related session. For example, if the service request is to create or initiate a new session, the NF consumer 336 may select a different NF set. However, if the service request relates to an on-going session, the NF consumer 336 may stay with the NF set 331 to avoid losing the on-going session and its related data. Even if the service request is to create or initiate a new session, the NF consumer 336 may stay with the NF set 331 if no alternative NF sets are available or have higher priority than the NF set 331.

As noted above, one issue with isolation events, in particular complete isolation events, is split-brain scenarios in which one or more NF within the NF set 331 is operating based on different data. To address split-brain scenarios, one of the PCFs 330A-C may be determined to be a cluster leader. The cluster leader will be the NF producer within the NF set 331 that handles all new and subsequent requests while one or more of the PCFs 330A-C are experiencing the isolation event. Because the cluster leader handles all new and subsequent requests received by the NF set 331 during an isolation event, the cluster leader may converge these requests into a “golden session state” that is used for recovery of the other sites. For example, if the PCF 330C is determined to be a cluster leader during an isolation event, then the PCF 330C may receive all requests from the NF consumer 336 during the isolation event. When the isolation event is rectified, the PCF 330C may replicate its session state to the PCF 330A and PCF 330B as the golden session state once they have recovered.

The cluster leader may be determined based on the priorities of each of the PCFs 330A-C within the NF set 331. In the case of a complete isolation event, all of the PCFs 330A-C may be isolated from each other as well as the NRF 328. As such, each of the PCFs 330A-C may publish (e.g., generate and transmit) a respective XSS header 346 containing a service priority. The PCF having the highest priority based on the service priorities of the PCFs 330A-C may be selected as the cluster leader. For example, if the service priorities of the PCF 330A, PCF 330B and, PCF 330C are 65530, 65531, and 65532, respectively, then the PCF 330A may be selected as the cluster leader. In scenarios where the PCF 330A subsequently completely fails, then the PCF 330B may automatically take over as cluster leader for the NF set 331.

During isolation events where one or more of the PCFs 330A-C are not affected and thus maintain the priority parameter from their NF profile, a cluster leader may be similarly selected. For example, if both the PCFs 330A-B experience an isolation event, and as such PCF 330C loses connectivity (e.g., communications 340B-C) with them, respectively, then the PCF 330C may be unable to replicate session data to its site mates. Since the PCF 330C is healthy and retains its priority parameter, the PCF 330C may be determined to be the cluster leader based on its priority and retain the golden session state to aid in session recovery for the PCFs 330A-B.

The cluster leader may be determined by the NF consumer 336 in some embodiments, while in other embodiments the cluster leader may be determined by an operator. The operator may be a vendor who deploys the PCFs 330A-C within its respective 5G network. During deployment the operator may determine which NF has priority to publish by, for example, determining a priority parameter for each of the PCFs 330A-C.

Returning now to the example in which the PCF 330A is experiencing an isolation event while the PCFs 330B-C remain active and healthy, the XSS engine 344 may continuously monitor the isolation event (458). For example, the XSS engine 344 may check at a set interval to see if the communications 340A-B have been reinstated and/or are functioning. In some cases, the XSS engine 344 may check the PCF's 330A connectivity with the PCFs 330B-C upon expiration of the validity period. If the XSS engine 344 determines that the isolation event is still ongoing, the XSS engine 344 may generate an updated XSS header 346 including an updated validity period. For example, if the first validity period expires, but the isolation event is ongoing, the XSS engine 344 may generate the updated XSS header 346 to indicate an updated validity period, which may extend the time period during which the service priority is applicable.

If upon its check or expiration of the validity period the XSS engine 344 determines that the isolation event is rectified (460), the XSS engine 344 may generate an updated XSS header 346 including a recovery status (462). The recovery status may include a recovery timestamp and the recovered service instance. Responsive to receiving the updated XSS header 436, the NF consumer 336 may revert back to the priority parameter for the PCF 330A during NF selection. In other words, once the isolation event rectifies and/or the validity period expires, the XSS engine 344 may stop publishing the XSS header 346, allowing the NF consumer 336 to reset the priority of the PCF 330A to the priority parameter of its NF profile, thereby resuming normal routing selection procedures.

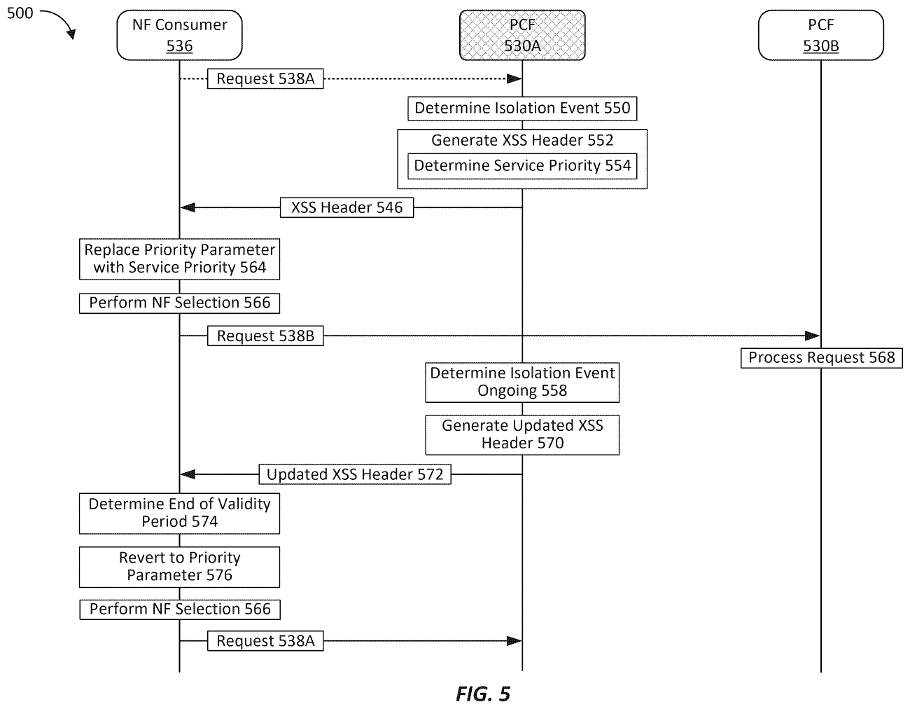

Referring now to FIG. 5, an example flow 500 illustrating use of an XSS header to dynamically update the service priority of a NF is provided, according to an embodiment herein. As shown, a NF consumer 536, which may be the same or similar to the NF consumers 236 or 336, may transmit a request 538A to a PCF 530A. The PCF 530A may be part of a NF set, such as the NF set 331. As such, the PCF 530A may have one or more site mates, such as PCF 530B. Although the flow 500 only illustrates the PCF 530B, it should be appreciated that there may be additional NFs, such as PCF 330C.

Responsive to receiving the request, the PCF 530A may determine an isolation event 550 and generate 552 an XSS header. As part of generating 552 the XSS header, the PCF 530A may determine a service priority 554 and a respective validity period during which the service priority 554 is applicable. Once generated, the PCF 530A may transmit the XSS header 546 to the NF consumer 536. In some embodiments, the XSS header 546 may be transmitted as part of a response to the request 538A. As noted above, in some embodiments, the PCF 530A may generate 552 the XSS header and transmit the XSS header 546 irrespective of receiving the request 538A, such as upon detection of the isolation event 550 or responsive to a health check API call.

Upon receiving the XSS header 546, the NF consumer 536 may replace 564 the priority parameter associated with the PCF 530A with the service priority in the XSS header 546. The NF consumer 536 may replace 564 the priority parameter with the service priority for the duration of the validity period or until the NF consumer 536 receives a notification that the PCF 530A has recovered from the isolation event.

The NF consumer 536 may perform NF selection 566 subsequent to receiving the XSS header 546. As such, the service priority for the PCF 530A may be used during NF selection 566. Due to the service priority indicating that the PCF 530A is among the least preferred NFs within its respective NF set, the NF consumer 536 may select another NF for service routing. In the illustrated flow 500, the NF consumer 500 selects the PCF 530B during the NF selection 566 and responsively sends request 538B to the PCF 530B. The PCF 530B may process the request 568 responsive to receiving the request 538B.

At some subsequent point, the PCF 530A may determine that the isolation event is ongoing 558. As noted above, the PCF 530A may periodically check its connectivity to its site mates and other NFs from which it is isolated. If the PCF 530A determines that the isolation event is ongoing, the PCF 530A may generate an updated XSS header 570. The updated XSS header 570 may update the validity period, such as by extending it. In some cases, the PCF 530A may determine that the isolation event 558 is ongoing responsive to determining that the validity period of the previous published XSS header 546 is about to expire or has expired. Once generated, the PCF 530A may transmit the updated XSS header 572 to the NF consumer 536.

The NF consumer 536 may also monitor for an end of the validity period. If the NF consumer 536 determines the end of the validity period 574, the NF consumer 536 may revert the priority of the PCF 530A back to the priority parameter 576. In other words, the NF consumer 536 may no longer use the service priority provided in the XSS header 546 for the PCF 530A during NF selection. As such, when the NF consumer 536 subsequently performs NF selection 566, the NF consumer 536 may select the PCF 530A based, in part, on its priority. Since the PCF 530A is no longer experiencing the isolation event, the PCF 530A may have a higher priority than the other NFs in its NF set and as such be selected by the NF consumer 536. Respectively, the NF consumer 536 may transmit a request 538A to the PCF 530A for service.

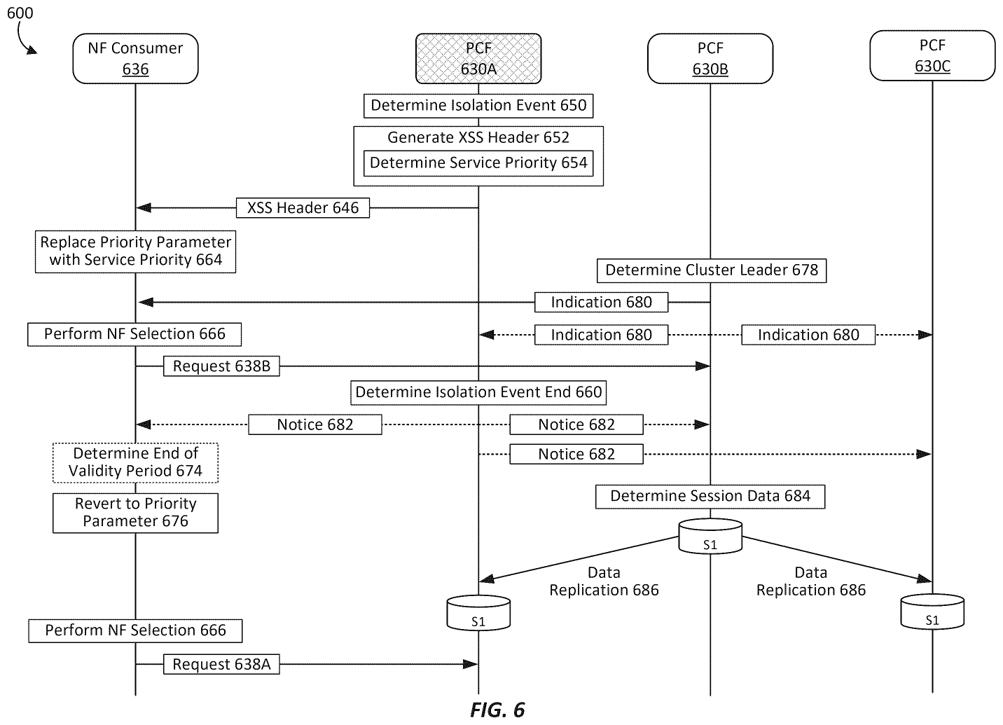

Referring now to FIG. 6, an example flow 600 illustrating use of an XSS header to dynamically update the service priority of a NF is provided, according to an embodiment herein. As shown, a PCF 630A, which may be the same or similar to the PCF 330A, may determine an isolation event 650. Responsive to determining the isolation event, the PCF 630A may generate 652 an XSS header. As part of generating 652 the XSS header, the PCF 630A may determine a service priority 654 and a validity period during which the service priority is applicable. Once generated, the PCF 630A may transmit the XSS header 646 to the NF consumer 636. Responsive to receiving the XSS header 646, the NF consumer 636 may replace 664 a priority parameter associated with the PCF 630A with the service priority 654.

As noted above, because one or more of the sites (e.g., NFs) within the NF set are degraded, illustrated here as the PCF 630A, a cluster leader may be determined for the NF set. It should be appreciated, that although the illustrated example illustrates only one NF as degraded (e.g., PCF 630A), in some embodiments, selection of a cluster leader may not be made until a majority of the NFs in a NF set are degraded, until all of the NFs in the NF set are degraded, or until all but one NF in the NF set are degraded. In other embodiments, a cluster leader may be selected any time one or more of the NFs in a NF set are degraded or experience an isolation event.

As shown, the PCF 630B may be selected as the cluster leader 678. That is, the PCF 630B may determine that it is the cluster leader 678 or an operator may determine the PCF 630B to be the cluster leader 678 based on the degraded status of the PCF 630A. In some embodiments, responsive to selecting the PCF 630B as the cluster leader, the PCF 630B or the operator (not shown) may provide an indication 680 notifying other NFs of the PCF's 630B status as cluster leader. For example, the PCF 630B may generate and transmit indications 680 to the NF consumer 636 and the PCFs 630A and 630C. As can be appreciated, by providing indication 680 to the NF consumer 636, the NF consumer 636 can be informed of the PCF's 630B status as cluster leader and proceed with routing all requests to the PCF 630B during the isolation event. In some embodiments, the PCF 630B may not provide an indication to PCFs 630A and 630C.

At some point subsequent to the PCF 630B being selected as cluster leader 678, the NF consumer 636 may perform NF selection 666. As noted above, since the PCF 630B is cluster leader, the NF consumer 636 may select and route requests 636B to the PCF 630B until the other PCFs have recovered from the isolation event. Once the PCF 630B receives the request 638B, the PCF 630B may process the request 638B and store the related data as part of a “golden session state” that will be used for recovery of the other sites.

The PCF 630A may monitor the isolation event to determine when it is rectified. As such, the PCF 630A may determine that the isolation event ends 660. In some embodiments, responsive to determining that the isolation event is rectified (e.g., ended), the PCF 630A may generate and send a notice 682 to the other sites. For example, the PCF 630A may send he notice 682 to one or more of the NF consumer 636, the PCFs 630B, or the PCF 630C. In some cases, the notice 682 may include an updated XSS header 646 including a recovery status of the PCF 630A. As noted above, the recovery status may include a recovery timestamp and a recovered service instance of the PCF 630A.

In embodiments where the PCF 630A does not generate the notice 682 and send it to the NF consumer 636, the NF consumer 636 may determine an end to the PCF's 630A degraded status by determining an end of the validity period 674 associated with the XSS header 646. As noted above, the XSS header 646 may include the service priority 654 and a validity period during which the service priority 654 is applicable. As such, once the validity period expires, the NF consumer 636 may revert from using the service priority 654 back to the priority parameter 676. If the NF consumer 636 does receive the notice 682 prior to determining the end of the validity period 674, the NF consumer 636 may revert back to the priority parameter 676 responsive to the notice 682.

As shown, the PCF 630B may receive the notice 682 that the PCF 630A has recovered from the isolation event. Once the PCF 630B determines that the PCF 63A is recovered, such as receiving the notice 682 or notices from any other degraded sites, the PCF 630B may determine the golden session data 684. As noted above, the golden session data may be session data for all service requests received and processed during the isolation event converged with session data from prior to the isolation event. As such, the golden session data may contain the most accurate information and data on the ongoing sessions or instances being provided to the NF consumer 636.

Once the isolation event is rectified and the other sites have recovered, the PCF 630B, as cluster leader, may replicate the golden session data, s1, to the other sites 686. By replicating the golden session data, s1, to the PCF 630A and PCF 630C, the other sites can be brought up-to-date on session data and continue function based on the most accurate information. As such, when the NF consumer 636 performs NF selection 666 and transmits the request 638A to the PCF 630A, when the PCF 630A processes the request 638A, the PCF 630A is working off of the most recent session data. As can be appreciated, it is crucial for NFs to work off of the most recent session data when servicing requests from the NF consumer 636 to ensure accurate and up-to-date service delivery. By receiving the latest session data (e.g., the golden session data, s1) from the PCF 630B, the PCF 630A can provide optimal performance, maintain session continuity, and adhere to dynamic network conditions and subscriber preferences, despite recently experiencing an isolation event.

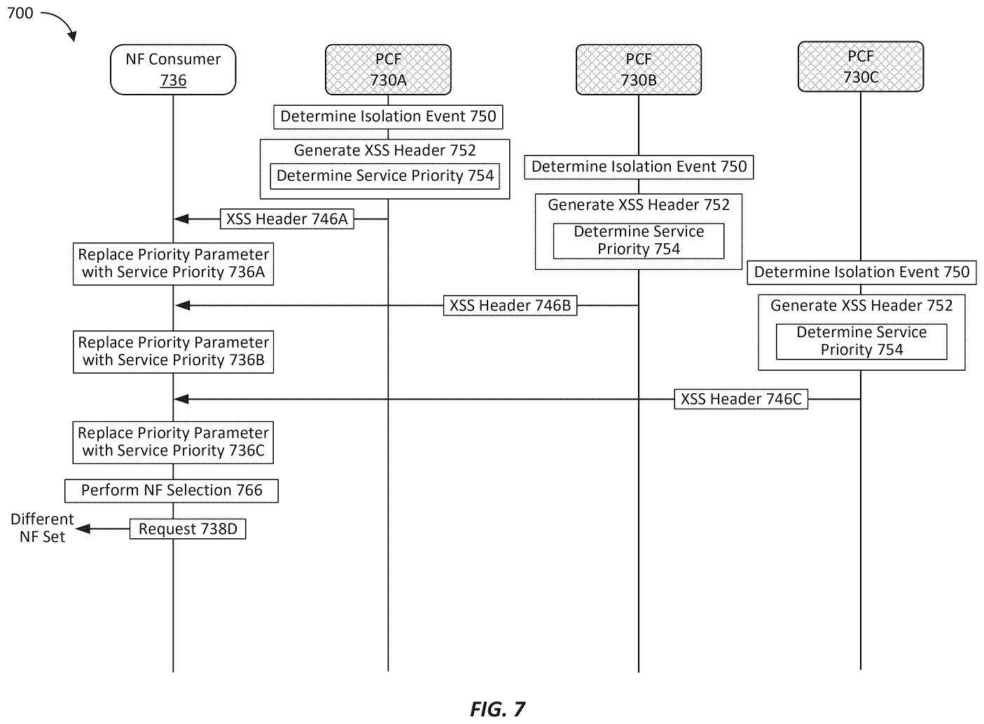

Referring now to FIG. 7, an example flow 700 illustrating use of an XSS header to dynamically update the service priority of multiple NFs within an NF set is provided, according to an embodiment herein. As shown, a PCF 730A, which may be the same or similar to the PCF 330A, may determine an isolation event 750. Responsive to determining the isolation event, the PCF 730A may determine a service priority 754 and generate 752 an XSS header including the service priority 754 and a validity period during which the service priority is applicable. Once generated, the PCF 730A may transmit the XSS header 746A to the NF consumer 736. Responsive to receiving the XSS header 746A, the NF consumer 736 may replace 764 a priority parameter associated with the PCF 730A with the service priority 754.

As illustrated, the PCF 730A may be part of a NF set including at least two other sites: PCF 730B and 730C. Both of the PCF 730B and 73C may also experience an isolation event 750 and generate 752 an XSS header containing a service priority 754 responsive to the isolation event. The PCF 730B may generate and send the XSS header 746B and the PCF 730B may generate and send the XSS header 746C to the NF consumer 736. When the NF consumer 736 receives the XSS header 746B the NF consumer 736 may replace the priority parameter associated with the PCF 730B with the service priority from the XSS header 746B. Similarly, when the NF consumer 736 receives the XSS header 746C from the PCF 730C, the NF consumer 736 may replace the priority parameter associated with the PCF 730B with the service priority from the XSS header 746C.

Accordingly, when the NF consumer 736 performs NF selection 766, the NF consumer 636 may use the service priorities for each of the PCFs 730A-C instead of their associated priority parameters. Because the service priorities cause the PCFs 730A-C to be some of the least preferred NFs (e.g., having low priorities), the NF consumer 736 may select an entirely different NF set. That is, the NF consumer 736 may decide to send the request 738D to a different NF set instead of sending it to any of the PCFs 730A-C. This may be particularly true in the case of initiating or creating a new session.

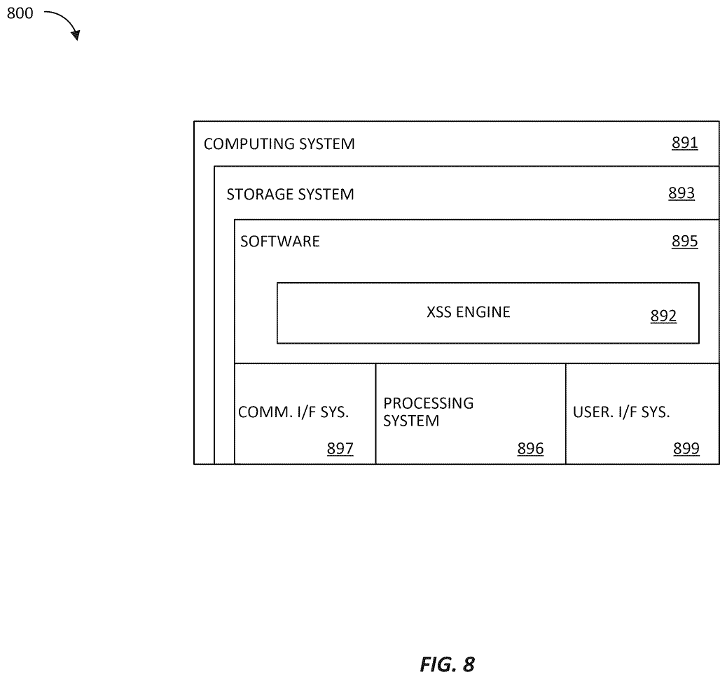

Referring now to FIG. 8, is a diagram of a system 800 configured to implement an XSS engine, according to an embodiment herein. The system 800 may be an example of an apparatus including a computing apparatus 891 that is representative of any system or collection of systems in which the various processes, systems, programs, services, and scenarios disclosed herein may be implemented. For example, computing apparatus 891 may be an example XSS engine, such as the XSS engine 344, a NF producer or consumer, such as the PCF 330A or NF consumer 336, or any of the subcomponents depicted in environments 100, 200, or 300 of FIGS. 1-3, respectively. Examples of computing apparatus 891 include, but are not limited to, server computers, desktop computers, laptop computers, routers, switches, web servers, cloud computing platforms, and data center equipment, as well as any other type of physical or virtual server machine, physical or virtual router, container, and any variation or combination thereof.

Computing apparatus 891 may be implemented as a single apparatus, system, or device or may be implemented in a distributed manner as multiple apparatuses, systems, or devices. Computing apparatus 891 may include, but is not limited to, processing system 896, storage system 893, software 895, communication interface system 897, and user interface system 899. Processing system 896 may be operatively coupled with storage system 893, communication interface system 897, and user interface system 899.

Processing system 896 may load and execute software 895 from storage system 893. Software 895 may include an XSS engine 892, which may be representative of any of the operations for providing an XSS engine or any of its related functions, as discussed with respect to the preceding figures. When executed by processing system 896, software 895 may direct processing system 896 to operate as described herein for at least the various processes, such as the process 400 or any of flows 500-700, operational scenarios, and sequences discussed in the foregoing implementations. Computing apparatus 891 may optionally include additional devices, features, or functionality not discussed for purposes of brevity.

In some embodiments, processing system 896 may comprise a micro-processor and other circuitry that retrieves and executes software 895 from storage system 893. Processing system 896 may be implemented within a single processing device but may also be distributed across multiple processing devices or sub-systems that cooperate in executing program instructions. Examples of processing system 896 may include general purpose central processing units, graphical processing units, application specific processors, and logic devices, as well as any other type of processing device, combinations, or variations thereof.

Storage system 893 may comprise any memory device or computer-readable storage medium readable by processing system 896 and capable of storing software 895. Storage system 893 may include volatile and nonvolatile, removable and non-removable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer-readable storage medium a propagated signal.

In addition to computer-readable storage medium, in some implementations storage system 893 may also include computer readable communication media over which at least some of software 895 may be communicated internally or externally. Storage system 893 may be implemented as a single storage device but may also be implemented across multiple storage devices or sub-systems co-located or distributed relative to each other. Storage system 893 may comprise additional elements, such as a controller, capable of communicating with processing system 896 or possibly other systems.

Software 895 (including the XSS engine 892 among other functions) may be implemented in program instructions that may, when executed by processing system 896, direct processing system 896 to operate as described with respect to the various operational scenarios, sequences, and processes illustrated herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 895 may include additional processes, programs, or components, such as operating system software, virtualization software, or other application software. Software 895 may also comprise firmware or some other form of machine-readable processing instructions executable by processing system 896.

In general, software 895 may, when loaded into processing system 896 and executed, transform a suitable apparatus, system, or device (of which computing apparatus 891 is representative) overall from a general-purpose computing system into a special-purpose computing system as described herein. Indeed, encoding software 895 on storage system 893 may transform the physical structure of storage system 893. The specific transformation of the physical structure may depend on various factors in different implementations of this description. Examples of such factors may include, but are not limited to, the technology used to implement the storage media of storage system 893 and whether the computer-storage media are characterized as primary or secondary storage, as well as other factors.

For example, if the computer-readable storage medium is implemented as semiconductor-based memory, software 895 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 897 may include communication connections and devices that allow for communication with other computing systems (not shown) over communication networks (not shown). Examples of connections and devices that together allow for inter-system communication may include network interface cards, antennas, power amplifiers, radio-frequency (RF) circuitry, transceivers, and other communication circuitry. The connections and devices may communicate over communication media to exchange communications with other computing systems or networks of systems, such as metal, glass, air, or any other suitable communication media.

Communication between the computing apparatus 891 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, which may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

As will be appreciated by one skilled in the art, aspects of the present invention may be embodied as a system, method, computer program product, and other configurable systems. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more memory devices or computer readable medium(s) having computer readable program code embodied thereon.

The foregoing examples and descriptions are described herein in the context of systems and methods for providing an XSS engine or one or more of its related functions. Those of ordinary skill in the art will realize that these descriptions are illustrative only and are not intended to be in any way limiting. Reference is made in detail to implementations of examples as illustrated in the accompanying drawings. The same reference indicators are used throughout the drawings and the description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. That is, the foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in an embodiment,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all the following interpretations of the word: any of the items in the list, all the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub combinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

### EXAMPLES

These illustrative examples are mentioned not to limit or define the scope of this disclosure, but rather to provide examples to aid understanding thereof. Illustrative examples are discussed above in the Detailed Description, which provides further description. Advantages offered by various examples may be further understood by examining this specification.

As used below, any reference to a series of examples is to be understood as a reference to each of those examples disjunctively (e.g., “Examples 1-4” is to be understood as “Examples 1, 2, 3, or 4”).
Example 1 is a computing apparatus comprising: a computer-readable storage medium; processor-executable instructions stored on the computer-readable storage medium; and one or more processors coupled to the computer-readable storage medium and configured to execute the processor-executable instructions to operate a first network function (NF) producer in a NF set within a 5G network, wherein the NF set comprise a plurality of NF producers that provide an instance to a NF consumer within the 5G network, such that the processor-executable instructions, when executed by the one or more processors, direct the computing apparatus, to at least: determine an isolation event, wherein the isolation event isolates the first NF producer from at least one or more NF producers within the NF set; generate a X-Service-State (XSS) header, wherein: the XSS header comprises an X-Service (XS) status indicating that the first NF producer is isolated from the at least one or more NF producers within the NF set; and the XS status comprises a service priority and a first validity period during which the service priority is applicable; and transmit the XSS header to the NF consumer, wherein responsive to receiving the XSS header the NF consumer uses the service priority for NF selection.
Example 2 is the computing apparatus of any previous or subsequent Example, wherein the processor-executable instructions, when executed by the one or more processors, further direct the computing apparatus to: determine that the isolation event is rectified; update the XS status to indicate a recovery status of the first NF producer, wherein the recovery status comprises a recovery timestamp and a recovered service instance; generate an updated XSS header to comprise the XS status indicating the recovery status of the first NF producer; and transmit the updated XSS header to the NF consumer.
Example 3 is the computing apparatus of any previous or subsequent Example, wherein the processor-executable instructions, when executed by the one or more processors, further direct the computing apparatus to: determine an expiration of the first validity period for the service priority; determine that the isolation event is on-going; update the XSS header to comprise a second validity period during which the service priority is applicable; and transmit the updated XSS header to the NF consumer.
Example 4 is the computing apparatus of any previous or subsequent Example, wherein the service priority indicates that the first NF producer comprises a cluster leader within the NF set, and wherein the processor-executable instructions, when executed by the one or more processors, further direct the computing apparatus to: determine that the isolation event is rectified; and replicating data associated with requests received during the isolation event to one or more of the NF producers in the NF set based on the first NF producer being the cluster leader.
Example 5 is the computing apparatus of any previous or subsequent Example, wherein the processor-executable instructions, when executed by the one or more processors, further direct the computing apparatus to: receive a service request from the NF consumer; and responsive to the service request, generate the XSS header comprising the XS status indicating the isolation event.
Example 6 is the computing apparatus of any previous or subsequent Example, wherein the processor-executable instructions to generate the XSS header, when executed by the one or more processors, further direct the computing apparatus to: generate the XS status within the XSS header to further comprise: a timestamp indicating a time at which the XSS header was generated; and a service instance indicating an instance impacted by the isolation event.
Example 7 is the computing apparatus of any previous or subsequent Example, wherein the processor-executable instructions to generate the XSS header, when executed by the one or more processors, further direct the computing apparatus to: determine that a second NF producer within the NF set comprises a first service priority indicating that the second NF producer is experience a second isolation event; and determine the service priority for the first NF producer as a second service priority based on the first service priority of the second NF producer, wherein the first service priority is different than the second service priority.
Example 8 is a method comprising: determining, by a first network function (NF) producer within a NF set comprising a plurality of NF producers, an isolation event, wherein: the plurality of NF producers within the NF set provides an instance to a NF consumer within a 5G network; and the isolation event isolates the first NF producer from at least one or more NF producers within the NF set; generating, by the first NF producer, a X-Service-State (XSS) header, wherein the XSS header comprises an X-Service (XS) status indicating that the first NF producer is isolated from the at least one or more NF producers within the NF set, wherein the XS status comprises a service priority and a first validity period during which the service priority is applicable; and transmitting, by the first NF producer, the XSS header to the NF consumer, wherein responsive to receiving the XSS header the NF consumer uses the service priority for NF selection.
Example 9 is the method of any previous or subsequent Example, wherein: the first NF producer comprises a NF profile comprising a priority parameter assigned to the first NF producer; and transmitting, by the first NF producer, the XSS header to the NF consumer causes the NF consumer to replace the priority parameter with the service priority for NF selection.
Example 10 is the method of any previous or subsequent Example, wherein the XS status further comprises: a timestamp indicating a time at which the XSS header was generated; and a service instance indicating an instance impacted by the isolation event.
Example 11 is the method of any previous or subsequent Example, wherein the method further comprises: responsive to receiving the XSS header, selecting, by the NF consumer, a second NF producer based on the XS status of the first NF producer.
Example 12 is the method of any previous or subsequent Example, wherein the method further comprises: determining that the first NF producer is a cluster leader within the NF set based on the service priority, wherein requests are routed to the first NF producer during the isolation event based on the first NF producer being the cluster leader; determining that the isolation event is rectified; and restoring data associated with the requests received by the first NF producer during the isolation event to one or more other NF producers in the NF set.
Example 13 is the method of any previous or subsequent Example, wherein the service priority causes the first NF producer to be a least preferred NF selection within a respective priority group.
Example 14 is the method of any previous or subsequent Example, wherein the first NF producer comprises one of a Packet Core Function (PCF), session management function (SMF), or unified data repository (UDR).
Example 15 is the method of any previous or subsequent Example, wherein the NF consumer comprises one of: a user equipment; service capability function (SCF); service control point (SCP); session management function (SMF); access and mobility management function (AMF); network exposure function (NEF); service enablement platform provider (SEPP); application function (AF); unified data repository (UDR); or charging function (CHF).
Example 16 is a computer-readable storage medium comprising processor-executable instructions, wherein the processor-executable instructions, in part, operate a first network function (NF) producer in a NF set to provide an instance to a NF consumer within a 5G network and such to cause one or more processors to: determine an isolation event, wherein the isolation event isolates the first NF producer from at least one or more NF producers within the NF set; generate a X-Service-State (XSS) header, wherein: the XSS header comprises an X-Service (XS) status indicating that the first NF producer is isolated from the at least one or more NF producers within the NF set; and the XS status comprises a service priority and a first validity period during which the service priority is applicable; and transmit the XSS header to the NF consumer, wherein responsive to receiving the XSS header the NF consumer uses the service priority for NF selection.
Example 17 is the computer-readable storage medium of any previous or subsequent Example, wherein the processor-executable instructions cause the one or more processors to further execute processor-executable instructions stored in the computer-readable storage medium to: determine that the isolation event is rectified; update the XS status to indicate a recovery status of the first NF producer, wherein the recovery status comprises a recovery timestamp and a recovered service instance; and generate an updated XSS header to comprise the XS status indicating the recovery status of the first NF producer.
Example 18 is the computer-readable storage medium of any previous or subsequent Example, wherein the processor-executable instructions cause the one or more processors to further execute processor-executable instructions stored in the computer-readable storage medium to: determine an expiration of the first validity period for the service priority; determine that the isolation event is on-going; update the first validity period within the XS status to a second validity period; generate an updated XSS header comprising the second validity period; and transmit the updated XSS header to the NF consumer.
Example 19 is the computer-readable storage medium of any previous or subsequent Example, wherein the service priority indicates that the first NF producer comprises a cluster leader within the NF set, and the processor-executable instructions cause the one or more processors to further execute processor-executable instructions stored in the computer-readable storage medium to: determine an expiration of the first validity period for the service priority; and replicate data associated with requests received during the isolation event to one or more of the NF producers in the NF set based on the first NF producer being the cluster leader.
Example 20 is the computer-readable storage medium of any previous or subsequent Example, wherein: the processor-executable instructions cause the one or more processors to further execute processor-executable instructions stored in the computer-readable storage medium to receive a service request from the NF consumer; and the processor-executable instructions to transmit the XSS header to the NF consumer cause the one or more processors to further execute processor-executable instructions stored in the computer-readable storage medium to transmit a response to the service request comprising the XSS header to the NF consumer.
Example 21 is a method comprising: receiving, by a NF consumer within a 5G network, a X-Service-State (XSS) header from a first NF producer within a first NF set, wherein: the first NF set comprises the first NF producer and one or more additional NF producers; the XSS header comprises a service priority of the first NF producer and a validity period during which the service priority is applicable; and the first NF producer comprises a NF profile comprising a priority parameter assigned to the first NF producer; replacing, by the NF consumer, the priority parameter associated with the first NF producer with the service priority from the XSS header for NF selection for a duration of the validity period; and selecting, by the NF consumer, an NF producer based on the service priority of the first NF producer.
Example 22 is the method of any previous or subsequent Example, wherein selecting, by the NF consumer, the NF producer based on the service priority of the first NF producer comprises selecting a second NF producer from the one or more additional NF producers within the first NF set, wherein: the second NF producer comprises a priority that is greater than the service priority of the first NF producer; and the priority of the second NF producer is selected from one of: a service priority associated with the second NF producer; or a priority parameter from a NF profile associated with the second NF producer.
Example 23 is the method of any previous or subsequent Example, wherein selecting, by the NF consumer, the NF producer based on the service priority of the first NF producer comprises: determining, by the NF consumer, a second NF set comprising two or more NF producers; and selecting, by the NF consumer, the NF producer from the second NF set based on the service priority of the first NF producer within the first NF set.
Example 24 is the method of any previous or subsequent Example, wherein selecting, by the NF consumer, the NF producer based on the service priority of the first NF producer comprises: receiving, by the NF consumer, a second XSS header from a second NF producer within the first NF set, wherein: the XSS header comprises a second service priority of the second NF producer and a validity period during which the second service priority is applicable; and the second NF producer comprises a second NF profile comprising a second priority parameter assigned to the second NF producer; replacing, by the NF consumer, the second priority parameter associated with the second NF producer with the second service priority from the second XSS header for NF selection (service routing) for the duration of the validity period; and selecting, by the NF consumer, the first NF producer based on the service priority of the first NF producer being greater than the second service priority of the second NF producer.
Example 25 is the method of any previous or subsequent Example, wherein the method further comprises: determining, by the NF consumer, an expiration of the validity period; and reverting, by the NF consumer, back to the priority parameter associated with the first NF producer for NF selection.
Example 26 is the method of any previous or subsequent Example, wherein the method further comprises: determining, by the NF consumer, a second NF producer within the first NF set as a cluster leader based on the service priority associated with the first NF producer; and routing, by the NF consumer, service requests exchanged during the validity period to the second NF producer based on the second NF producer being the cluster leader.
Example 27 is the method of any previous or subsequent Example, wherein the method further comprises: receiving, by the NF consumer, an updated XSS header from the first NF producer, wherein: the updated XSS header comprises a recovery status of the first NF producer; and the recovery status comprises a recovery timestamp and one or more recovered service instances; and routing, by the NF consumer, service requests to the first NF set based on the recovery status of the first NF producer.

What is claimed is:

1. A computing apparatus comprising:
a computer-readable storage medium;
processor-executable instructions stored on the computer-readable storage medium; and
one or more processors coupled to the computer-readable storage medium and configured to execute the processor-executable instructions to operate a first network function (NF) producer in a NF set within a 5G network, wherein the NF set comprise a plurality of NF producers that provide an instance to a NF consumer within the 5G network, such that the processor-executable instructions, when executed by the one or more processors, direct the computing apparatus, to at least:
determine an isolation event, wherein the isolation event isolates the first NF producer from at least one or more NF producers within the NF set;
generate a X-Service-State (XSS) header, wherein:
the XSS header comprises an X-Service (XS) status indicating that the first NF producer is isolated from the at least one or more NF producers within the NF set; and
the XS status comprises a service priority and a first validity period during which the service priority is applicable; and
transmit the XSS header to the NF consumer, wherein responsive to receiving the XSS header the NF consumer uses the service priority for NF selection.

2. The computing apparatus of claim 1, wherein the processor-executable instructions, when executed by the one or more processors, further direct the computing apparatus to:
determine that the isolation event is rectified;
update the XS status to indicate a recovery status of the first NF producer, wherein the recovery status comprises a recovery timestamp and a recovered service instance;
generate an updated XSS header to comprise the XS status indicating the recovery status of the first NF producer; and
transmit the updated XSS header to the NF consumer.

3. The computing apparatus of claim 1, wherein the processor-executable instructions, when executed by the one or more processors, further direct the computing apparatus to:
determine an expiration of the first validity period for the service priority;
determine that the isolation event is on-going;
update the XSS header to comprise a second validity period during which the service priority is applicable; and
transmit the updated XSS header to the NF consumer.

4. The computing apparatus of claim 1, wherein the service priority indicates that the first NF producer comprises a cluster leader within the NF set, and wherein the processor-executable instructions, when executed by the one or more processors, further direct the computing apparatus to:
determine that the isolation event is rectified; and
replicating data associated with requests received during the isolation event to one or more of the NF producers in the NF set based on the first NF producer being the cluster leader.

5. The computing apparatus of claim 1, wherein the processor-executable instructions, when executed by the one or more processors, further direct the computing apparatus to:
receive a service request from the NF consumer; and
responsive to the service request, generate the XSS header comprising the XS status indicating the isolation event.

6. The computing apparatus of claim 1, wherein the processor-executable instructions to generate the XSS header, when executed by the one or more processors, further direct the computing apparatus to:
generate the XS status within the XSS header to further comprise:
a timestamp indicating a time at which the XSS header was generated; and
a service instance indicating an instance impacted by the isolation event.

7. The computing apparatus of claim 1, wherein the processor-executable instructions to generate the XSS header, when executed by the one or more processors, further direct the computing apparatus to:
determine that a second NF producer within the NF set comprises a first service priority indicating that the second NF producer is experience a second isolation event; and
determine the service priority for the first NF producer as a second service priority based on the first service priority of the second NF producer, wherein the first service priority is different than the second service priority.

8. A method comprising:
determining, by a first network function (NF) producer within a NF set comprising a plurality of NF producers, an isolation event, wherein:
the plurality of NF producers within the NF set provides an instance to a NF consumer within a 5G network; and
the isolation event isolates the first NF producer from at least one or more NF producers within the NF set;
generating, by the first NF producer, a X-Service-State (XSS) header, wherein the XSS header comprises an X-Service (XS) status indicating that the first NF producer is isolated from the at least one or more NF producers within the NF set, wherein the XS status comprises a service priority and a first validity period during which the service priority is applicable; and
transmitting, by the first NF producer, the XSS header to the NF consumer, wherein responsive to receiving the XSS header the NF consumer uses the service priority for NF selection.

9. The method of claim 8, wherein:
the first NF producer comprises a NF profile comprising a priority parameter assigned to the first NF producer; and
transmitting, by the first NF producer, the XSS header to the NF consumer causes the NF consumer to replace the priority parameter with the service priority for NF selection.

10. The method of claim 8, wherein the XS status further comprises:
a timestamp indicating a time at which the XSS header was generated; and
a service instance indicating an instance impacted by the isolation event.

11. The method of claim 8, wherein the method further comprises:
responsive to receiving the XSS header, selecting, by the NF consumer, a second NF producer based on the XS status of the first NF producer.

12. The method of claim 8, wherein the method further comprises:
determining that the first NF producer is a cluster leader within the NF set based on the service priority, wherein requests are routed to the first NF producer during the isolation event based on the first NF producer being the cluster leader;
determining that the isolation event is rectified; and
restoring data associated with the requests received by the first NF producer during the isolation event to one or more other NF producers in the NF set.

13. The method of claim 8, wherein the service priority causes the first NF producer to be a least preferred NF selection within a respective priority group.

14. The method of claim 8, wherein the first NF producer comprises one of a Packet Core Function (PCF), session management function (SMF), or unified data repository (UDR).

15. The method of claim 8, wherein the NF consumer comprises one of:
a user equipment;
service capability function (SCF);
service control point (SCP);
session management function (SMF);
access and mobility management function (AMF);
network exposure function (NEF);
service enablement platform provider (SEPP);
application function (AF);
unified data repository (UDR); or
charging function (CHF).

16. A computer-readable storage medium comprising processor-executable instructions, wherein the processor-executable instructions, in part, operate a first network function (NF) producer in a NF set to provide an instance to a NF consumer within a 5G network and such to cause one or more processors to:
determine an isolation event, wherein the isolation event isolates the first NF producer from at least one or more NF producers within the NF set;
generate a X-Service-State (XSS) header, wherein:
the XSS header comprises an X-Service (XS) status indicating that the first NF producer is isolated from the at least one or more NF producers within the NF set; and
the XS status comprises a service priority and a first validity period during which the service priority is applicable; and
transmit the XSS header to the NF consumer, wherein responsive to receiving the XSS header the NF consumer uses the service priority for NF selection.

17. The computer-readable storage medium of claim 16, wherein the processor-executable instructions cause the one or more processors to further execute processor-executable instructions stored in the computer-readable storage medium to:
determine that the isolation event is rectified;
update the XS status to indicate a recovery status of the first NF producer, wherein the recovery status comprises a recovery timestamp and a recovered service instance; and
generate an updated XSS header to comprise the XS status indicating the recovery status of the first NF producer.

18. The computer-readable storage medium of claim 16, wherein the processor-executable instructions cause the one or more processors to further execute processor-executable instructions stored in the computer-readable storage medium to:
determine an expiration of the first validity period for the service priority;
determine that the isolation event is on-going;
update the first validity period within the XS status to a second validity period;
generate an updated XSS header comprising the second validity period; and
transmit the updated XSS header to the NF consumer.

19. The computer-readable storage medium of claim 16, wherein the service priority indicates that the first NF producer comprises a cluster leader within the NF set, and the processor-executable instructions cause the one or more processors to further execute processor-executable instructions stored in the computer-readable storage medium to:
determine an expiration of the first validity period for the service priority; and
replicate data associated with requests received during the isolation event to one or more of the NF producers in the NF set based on the first NF producer being the cluster leader.

20. The computer-readable storage medium of claim 16, wherein:
the processor-executable instructions cause the one or more processors to further execute processor-executable instructions stored in the computer-readable storage medium to receive a service request from the NF consumer; and
the processor-executable instructions to transmit the XSS header to the NF consumer cause the one or more processors to further execute processor-executable instructions stored in the computer-readable storage medium to transmit a response to the service request comprising the XSS header to the NF consumer.
